(19) United States
(12) Patent Application Publication
(10) Pub. No.: US 2010/0260511 A1
(43) Pub. Date: Oct. 14, 2010

(54) IMAGE FORMING APPARATUS

(75) Inventors: Katsuhiro Kojima, Mishima-shi (JP); Masaki Ojima, Mishima-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/753,973

(22) Filed: Apr. 5, 2010

(30) Foreign Application Priority Data
Apr. 8, 2009 (JP) 2009-094133
Mar. 11, 2010 (JP) 2010-054867

(51) Int. Cl. G03G 15/00; G03G 15/02; G03G 15/06; G03G 15/16

(52) U.S. Cl. 399/46; 399/71; 399/50; 399/55; 399/66

(57) ABSTRACT

The present invention is directed to clean a collecting member without making toner on the collecting member enter a developing device and to reduce deterioration in throughput accompanying the operation of cleaning the collecting member with a simple configuration. A control unit is provided that executes cleaning operation of transferring toner collected by a cleaning roller to a conveyance belt via a photosensitive drum and collecting the toner by a cleaning device. In the cleaning operation, the control unit develops at least a surface part to which the toner is transferred from the cleaning roller, in the surface portion of the photosensitive drum with the toner by the developing device.

### BACKGROUND OF THE INVENTION

1. Field of the Invention

The present invention relates to an image forming apparatus such as a copying machine or a printer, having the function of forming an image on a recording material such as a sheet.

2. Description of the Related Art

In recent years, a color image forming apparatus is being spread. A color image forming apparatus has, for each of four colors, a station including a photosensitive drum, a charging device, a developing device, and a cleaning device. A method of performing a step of sequentially transferring an image on a recording material on a recording material conveying member or an intermediate transfer member for a single path is proposed. Although the method (tandem method) has an advantage that it can support high-speed color recording, miniaturization of the apparatus is limited due to the existence of four stations. As a general cleaning device, there is a device of pressing a cleaning member against the photosensitive drum to hold residual toner, scraping the toner to a waste toner container, and catching it. In such a device, a blade-type cleaning member is used. However, in the case of making the cleaning member come into contact with the photosensitive drum, the performance of collecting the residual toner is high, but the waste toner container has to be provided for each of the stations. It is therefore feared that the apparatus becomes inevitably large. In particularly, in a tandem image forming apparatus having a plurality of stations, further miniaturization of the apparatus is in demand.

In view of such a point, an image forming apparatus eliminating the need for providing a waste toner container for each station is proposed. For example, it is an apparatus that, after a step of transferring a tone image formed on a photosensitive drum, makes residual toner and retransfer toner adhered on the surface of the photosensitive drum temporarily electrostatically adhered to a holding member, transfers the toner held at the time of forming no image onto the photosensitive drum, and collects the toner by the developing device. However, in a color image forming apparatus, in a holding member, not only the residual toner but also the retransfer toner as toner of other stations is also collected. When the toner on the holding member in which colors are mixed is transferred onto the photosensitive drum and collected by the developing device, it is feared that color mixture occurs in the toners in the developing device and the colors fluctuate.

To address the drawback, a method of collecting toner adhered to a holding member in a place out of a developing device is proposed. For example, Japanese Patent Laid-Open Publication No. 08(1996)-030163 discloses an image forming apparatus that prevents occurrence of color mixture in a developing device to obtain a high-quality image by transferring toner on a holding member directly onto a recording material conveying member and discarding the toner to a cleaning device of the recording material conveying member. The holding member in the Japanese Patent Laid-Open Publication No. 08(1996)-030163 is provided so that it can come into contact with both of a photosensitive drum and the recording material conveying member. The holding member temporarily holds residual toner on the photosensitive drum after a transfer step, after completion of an image forming operation, is apart from the photosensitive drum, and comes into contact with the recording material conveying member.

As another method of collecting toner on the holding member to a place other than a developing device, for example, in Japanese Patent Laid-Open Publication Nos. 2004-20700 and 2000-29365, toner adhered on the holding member is transferred to the photosensitive drum, further, transferred from the photosensitive drum to an intermediate transfer member, and discarded in the cleaning device of the intermediate transfer member. In the operation, the developing device is retracted so as to prevent entry of the toner transferred to the photosensitive drum into the developing device.

On the other hand, like in the Japanese Patent Laid-Open Publication No. 2009-042493, there is an apparatus performing toner discharging operation of discharging deteriorated toner from a developing device in order to maintain developability.

However, when the holding member can come into contact with both of the photosensitive drum and the recording material conveying member as described in Japanese Patent Laid-Open Publication No. 08(1996)-030163, the number of parts increases, and the cost also increases. On the other hand, like in Japanese Patent Laid-Open Publication Nos. 2004-20700 and 2000-29365, the method of retracting the developing device for the cleaning operation of the holding member requires time to retract and reset the position of the developing device. Consequently, the time required for the cleaning operation of the holding member becomes longer, and it is feared that the throughput deteriorates. Further, it is also feared that since the mechanism of retracting the developing device is necessary, the cost rises.

As disclosed in Japanese Patent Laid-Open Publication Nos. 08(1996)-030163, 2004-20700, and 2000-29365, there is also a device performing an operation of cleaning toner on a charging roller which comes into contact with the photosensitive drum, not the operation of cleaning toner adhered on the holding member.

There is also a case that, in addition to the operation of cleaning the contact member which comes into contact with the photosensitive drum, such as a holding member or a charging roller, but also an operation of discharging toner from the developing device are performed like in Japanese Patent Laid-Open Publication No. 2009-042493. In this case, each of the cleaning of the contact member and the operation of discharging toner from the developing device is performed. Due to this, time in which the image formation is interrupted increases. It is therefore feared that the throughput of image formation deteriorates.

### SUMMARY OF THE INVENTION

The present invention has been made in view of the above-described circumstances and an object of the invention is to reduce deterioration in throughput by operation of cleaning a contact member and operation of discharging toner of a developing device by suppressing entry of toner on the contact member into the developing device with a simple configuration.

Another object of the present invention is to provide an image forming apparatus including:
a rotatable image bearing member;
a charging unit that charges the image bearing member in a charging position;
an exposing unit that exposes the image bearing member to form an electrostatic latent image on the image bearing member;
a developing unit of a reversal development type that performs development by transferring a developer to a part exposed by the exposing unit in the electrostatic latent image formed on the image bearing member;
a transfer member that transfers a developer image on the image bearing member developed by the developing unit in a transfer position to a recording material carried by a recording material conveying member or an intermediate transfer member;
a holding member that is disposed on the downstream side of the transfer position in the rotating direction of the image bearing member and on the upstream side of the charging position as coming into contact with the image bearing member, when voltage is applied, holds the developer;
a collecting member that collects the developer adhered to the recording material conveying member or the intermediate transfer member; and
a control unit that controls voltage applied to the transfer member and the holding member,
wherein the control unit controls the voltage applied to the transfer member and the holding member to transfer the developer held on the holding member to the recording material conveying member or the intermediate transfer member via the image bearing member, and executes cleaning operation of performing the collection by the collecting member, and
at the time of the cleaning operation, executes a developer discharging operation of exposing at least a part of a surface part to which the developer is transferred from the holding member in the surface part of the image bearing member by the exposing unit and transferring the developer from the developing unit.

Further features of the present invention will become apparent from the following description of exemplary embodiments (with reference to the attached drawings).

### BRIEF DESCRIPTION OF THE DRAWINGS

FIG. 1 is a cross-sectional view showing a schematic configuration of an image forming apparatus to which the present invention can be applied;

FIG. 2 is a cross-sectional view showing a schematic configuration of a process cartridge which is detachable from the image forming apparatus;

FIG. 3 is a timing chart of printing operation and cleaning sequence;

FIG. 4 is a graph showing the relation between toner amount on a photosensitive drum and potential of the photosensitive drum after exposure;

FIG. 5 is a timing chart of the printing operation and charging roller cleaning sequence;

FIG. 6 is a block diagram showing the relations with a CPU;

FIG. 7 is a diagram showing the relation between the photosensitive drum and a nip portion of a cleaning roller;

FIG. 8 is a timing chart of the printing operation and the cleaning sequence in an image forming apparatus of a third embodiment;

FIG. 9 is a timing chart of the printing operation and the cleaning sequence in an image forming apparatus of a fourth embodiment; and

FIG. 10 is a cross-sectional, view showing a schematic configuration of a process cartridge which can be detchably attached to the image forming apparatus of the third embodiment;

FIG. 11 is a cross-sectional view showing a schematic configuration of an image forming apparatus to which the present invention can be applied.

### DESCRIPTION OF THE EMBODIMENTS

In the following, embodiments of the present invention will be illustratively described in detail with reference to the drawings. The dimensions, materials, shapes, relative layout, and the like of components described in the embodiments are to be appropriately changed according to the configuration of an apparatus to which the present invention is applied and various conditions. The scope of the invention is not limited to the following embodiments.

### First Embodiment

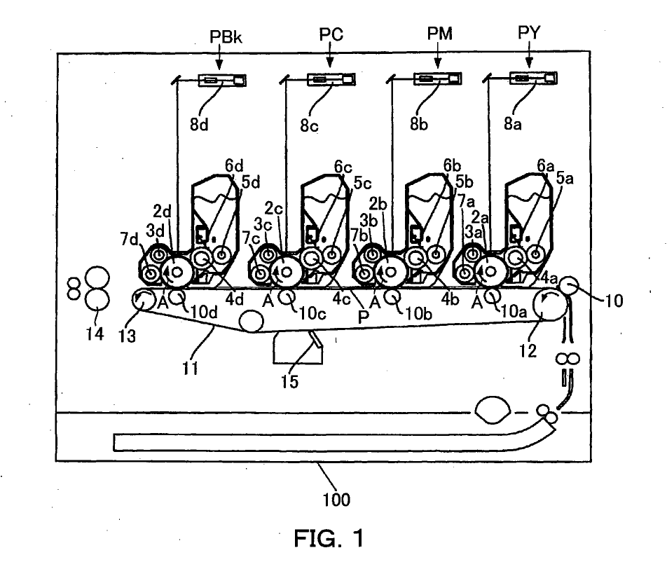

FIG. 1 is a cross-sectional view showing a schematic configuration of an image forming apparatus 100 to which the present invention can be applied. First, using FIG. 1, the general configuration of the image forming apparatus 100 will be described. The longitudinal direction in the following description corresponds to the width direction of a recording material which is orthogonal to a recording material conveying direction in an image formation face of the recording material, and a rotation axis direction of a photosensitive drum 2 as a photosensitive member having a drum shape as a rotatable image bearing member.

### <General Configuration of Image Forming Apparatus>

The image forming apparatus 100 is a tandem full-color image forming apparatus in which image forming units PY, PM, PC, and PBk dedicated to yellow (Y), magenta (M), cyan (C), and black (K), respectively, are disposed in parallel. The image forming apparatus 100 can print a full-color image made of toner images (developer images) of four colors formed by toner as a developer, and can also print an image of a single color. A full-color image is printed by the image forming apparatus 100 as follows. First, toner images according to image information of the different colors are formed on the photosensitive drums 2 (image bearing members) at predetermined timings by the image forming units PY, PM, PC, and PBk. The toner images on the photosensitive drums 2 are sequentially transferred onto a recording material P conveyed by a conveyance belt 11 as a recording material conveying member, and the toner images of the four colors are overlapped on the recording material P. The recording material P on which the toner images of the four colors are transferred is discharged to a discharge tray via a fixing device 14.

### <Description of Image Forming Unit>

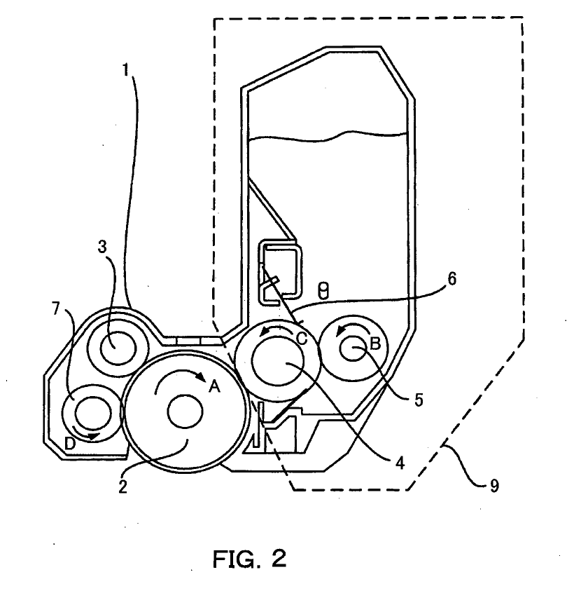

Next, the image forming units will be described by using FIG. 2. FIG. 2 is a cross-sectional view showing a schematic configuration of a process cartridge 1 which is detachable from the image forming apparatus 100. The photosensitive drum 2 is a rotary member on which an OPC (organic optical semiconductor) photosensitive layer is applied in width of 250 mm in the longitudinal direction on the outer peripheral face of an aluminum cylinder having a diameter of 24 mm. The photosensitive drum 2 is rotated by driving unit (not shown) at a process speed (circumferential velocity) of 100 mm/sec. A charging roller 3 (charging member) as charging unit is a roller-shaped member having a diameter of 12 mm and has an effective charging width of 235 mm. On the core of the charging roller 3, an urethane rubber layer as a base layer and a fluorine resin layer as a surface layer are stacked. The charging roller 3 is pressed against the surface of the photosensitive drum 2 with predetermined contact ratio in a charging position, and a charging nip portion is formed between the charging roller 3 and the photosensitive drum 2. A DC voltage as a charging bias is applied to the core of the charging roller 3. The peripheral face of the photosensitive drum 2 is charged by generating discharge in a very small gap near the charging nip portion.

Next, an electrostatic latent image is formed on the surface of the charged photosensitive drum 2 by an exposing device 8 as exposing unit. According to an image signal corresponding to an input signal, a semiconductor laser emits a laser beam. The laser beam is reflected by a polygon mirror (not shown) which rotates at high speed, passes through an imaging lens group (not shown), and is applied to the photosensitive drum 2. The effective exposure width in the main scan direction of the exposing device 8 is 230 mm and is wider than a toner application width which will be described later and the maximum passage width of the recording material P (the direction orthogonal to the conveyance direction). The electrostatic latent image formed on the photosensitive drum 2 by the laser beam irradiation is visualized by a developing device 9 as developing unit.

Next, the developing device 9 will be described. In the embodiment, a monocomponent nonmagnetic contact developing method is employed as a developing method. The developing device 9 develops a latent image by a reversal development (discharged area development) method of transferring a developer on the exposed part in the development position. In the developing device 9, 150 g of a nonmagnetic component toner is charged. A toner supply roller 5 rotating in the direction of the arrow B in the diagram is a sponge roller obtained by providing the periphery of the core with urethane foam. Since the toner supply roller 5 and a development roller 4 as a developer carrying member are disposed in contact with each other, toner can be supplied onto the development roller 4. The development roller 4 is a roller-shaped member having a diameter of 16 mm. On the core of the development roller 4, a silicone rubber layer as a base layer and an urethane rubber layer in which carbon is mixed as a surface layer are stacked. The development roller 4 is rotated at circumferential velocity (surface velocity) of 150 mm/sec in the direction of the arrow C in the diagram by driving unit (not shown).

The toner on the development roller 4 supplied from the toner supply roller 5 is regulated to uniform layer thickness in toner application width of 215 mm by a development blade 6 and is negatively charged. As the development blade 6 of the embodiment, a stainless plate whose tip shape is an L shape is employed. A DC developing bias of −400 V is applied to the core of the development roller 4. In the development nip portion in which the development roller 4 and the photosensitive drum 2 are in contact, the toner on the development roller 4 is adhered to the electrostatic latent image on the photosensitive drum 2, thereby forming a toner image. When the DC voltage is applied to a transfer roller 10 as a transfer member, the toner image formed on the photosensitive drum 2 is transferred onto the recording material P carried and conveyed on the conveyance belt 11. The position where the transfer is performed will be called a transfer position.

To collect toner adhered on the surface of the photosensitive drum 2 after the transfer step (after the transfer operation) and temporarily hold it, a cleaning roller 7 as a holding member is provided. The cleaning roller 7 is provided on the downstream side of the transfer position and on the upstream side of the charging position and is also a holding member for temporarily holding the toner adhered to the photosensitive drum 2 after the transfer operation. The cleaning roller 7 is a roller-shaped rotation member having a diameter of 12 mm. A semiconducting urethane foam sponge layer is formed around the core with predetermined thickness. The width of the urethane foam sponge layer in the longitudinal direction is set to be 215 mm which is the same as that of the toner application. The gear drive is performed so that the urethane foam sponge layer comes into contact with the surface part of the photosensitive drum 2 and rotates in the direction of the arrow D in the diagram at equal velocity to the photosensitive drum 2, that is, while being in contact with the surface of the photosensitive drum 2.

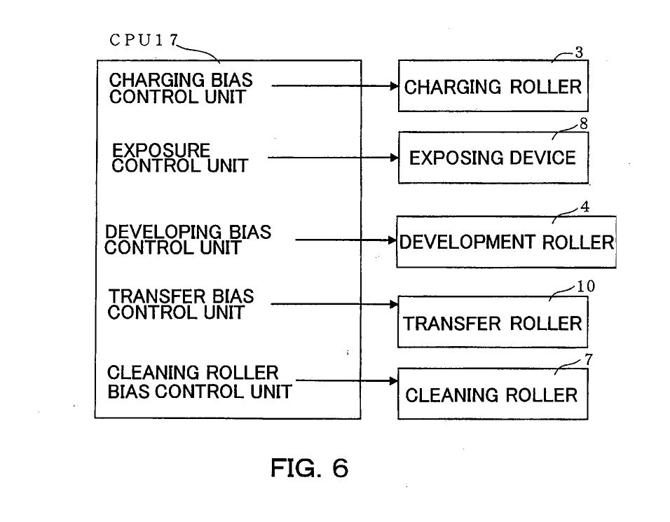

FIG. 6 is a block diagram showing the relations between a CPU 17 as control unit and the units to be controlled. The CPU 17 has a charging bias control unit, a developing bias control unit, a transfer bias control unit, and a cleaning roller bias control unit which control voltages applied to the charging roller 3, the development roller 4, the transfer roller 10, and the cleaning roller 7, respectively. The voltage control includes control of the value of voltage and also turn-off of the voltage. The CPU also has an exposure control unit which controls exposure of the exposing device 8. The exposure control unit controls the timing of exposure of the exposing device and the amount of exposure.

The cleaning roller 7 comes into contact with the surface of the photosensitive drum 2 to eliminate toner adhered on the photosensitive drum 2 after the transfer step, thereby preventing the toner from being adhered to the surface of the charging roller 3. During executing of a print job (at the time of image formation), the toner adhered on the photosensitive drum 2 after the transfer step is temporarily accumulated on the cleaning roller 7. By executing a cleaning sequence (cleaning operation) when no image is formed, the toner accumulated on the cleaning roller 7 is collected (discarded) by a cleaning device 15 as a collecting member via the photosensitive drum 2 and the conveyance belt 11. The cleaning sequence is executed by control unit provided for the image forming apparatus 100. In the cleaning sequence, a potential gradient is generated between the cleaning roller 7 and the photosensitive drum 2 and the transfer roller 10, the toner accumulated on the cleaning roller 7 is discarded to the cleaning device 15 for cleaning the conveyance belt 11 via the photosensitive drum 2. To generate the potential gradient between the photosensitive drum 2 and the cleaning roller 7, a variable source as voltage applying unit is connected to the core of the cleaning roller 7 so that bias made by a DC component can be applied.

When the toner accumulated on the cleaning roller 7 enters the developing device 9 during execution of a print job, color mixture occurs in the toner in the developing device 9. It is consequently feared that fluctuation in color of a printed image occurs. In the embodiment, to prevent toner accumulated on the cleaning roller 7 from being transferred to the development roller 4 at the time of passing through the contact nip portion between the photosensitive drum 2 and the development roller 4 in the cleaning sequence, the following operation is executed. In the cleaning sequence, toner discharging operation (developer discharging operation) of developing (supplying) the toner on the development roller 4 onto the photosensitive drum 2 is executed. When the toner is developed from the development roller 4 onto the photosensitive drum 2 by the toner discharging operation, it becomes difficult for the toner to move from the photosensitive drum 2 to the development roller 4 against the flow of the toner, so that entry of the mixed-color toner to the developing device 9 can be suppressed.

### <Toner Ejecting Operation>

Next, the details of the toner discharging operation executed in the cleaning sequence will be described. In an electrophotographic image forming apparatus, due to variations in the particle diameter of toner, the surface state of the toner, the charging state of the toner, and the like, the development characteristic varies among the toners. At the time of forming a toner image on an electrostatic latent image, a toner having high developability tends to be preferentially used for development among the toners adhered to the development roller 4.

Consequently, as the printing operation is performed, the ratio of a toner having low developability increases near the development roller 4. Since the number of chances that the toner having low developability slides with the development blade 6 and the toner supply roller 5 is large, toner deterioration such as detachment of external additive adhered on the toner surface, embedding of the external additive to the toner surface, and the like occurs. Since the chargeability and flowability of the deteriorated toner deteriorates, there is the possibility that problems such as deterioration in fog, decrease in transfer efficiency, deterioration in re-transfer, adhesion to the development roller 4 and the development blade 6 and the like occur.

As a countermeasure against the problems, in the embodiment, the toner discharging operation for the purpose of forcedly making toner having low developability adhered on the development roller 4 consumed on the photosensitive drum 2 is executed. By executing the toner discharging operation at the same time with the cleaning sequence, the toner on the cleaning roller 7 can be prevented from entering the developing device 9 without separating the development roller 4 and the photosensitive drum 2. Further, since the cleaning sequence and the toner discharging operation can be performed at the same time, there is also an advantage that the frequency of the sequence can be reduced.

### <Cleaning Sequence and Toner Ejecting Operation>

In the embodiment, it is set so that, as a timing of executing the cleaning sequence, even when only a solid black image with which the residual toner is the largest is printed, poor toner collection by the cleaning roller 7 does not occur. The timing of executing the cleaning sequence is set after completion of image forming operation performed when the cumulated number of prints (the number of images formed) since the last cleaning sequence is executed is 100.

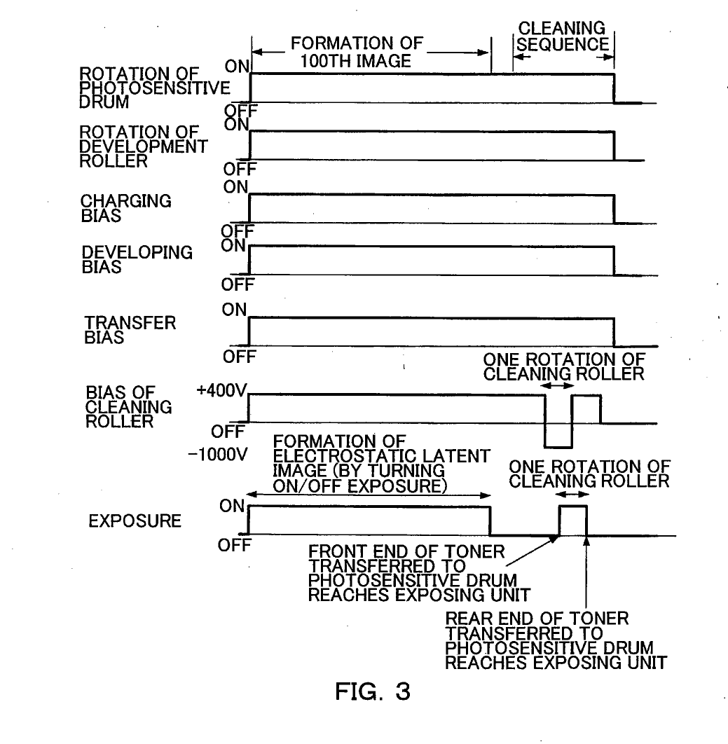

The flow of the image forming operation for the 100th image sheet and the cleaning sequence executed after the operation will be described with reference to FIG. 3. During image formation, by applying −1200 V as a charge bias to the core of the charging roller 3, the surface potential of the photosensitive drum 2 is charged to about −700 V. A toner image is developed on the electrostatic latent image on the photosensitive drum 2 by applying −400 V as the developing voltage to the core of the development roller 4. To transfer the toner image on the photosensitive drum 2 onto the recording material P, +1000 V is applied as a transfer bias to the core of the transfer roller 10. Since the toner of the negative polarity among the toners adhered on the photosensitive drum 2 after the transfer step is temporarily accumulated on the cleaning roller 7, +400 V is applied to the core of the cleaning roller 7.

After completion of the image forming operation on the 100th image sheet, the cleaning sequence is executed. In the cleaning sequence, as the voltages applied to the charging roller 3, the development roller 4, and the transfer roller 10, the same voltage as that in the image forming operation is continuously applied. Only the voltage applied to the cleaning roller 7 is changed. The voltage applied to the cleaning roller 7 is changed from +400 V to −1000 V (hereinbelow, the bias will be called cleaning bias) to generate the potential gradient. The surface potential of the photosensitive drum 2 is charged to −700 V which is the same as that of the image formation by the charging roller 3. After that, the surface potential is subjected to the transfer bias and becomes 0 V to about −100 V when the surface of the photosensitive drum 2 comes again to the position which comes into contact with the cleaning roller 7. Therefore, by generating the potential gradient between the photosensitive drum 2 and the cleaning roller 7, the toner of the negative polarity accumulated on the cleaning roller 7 is transferred onto the photosensitive drum 2. Transfer of the toner between two members will now be described. When the potential gradient is generated between two members, the toner is attracted by one of the members by the force of electric field. The attraction direction is a direction toward the member having a larger potential of the polarity opposite to the charging polarity of the toner. In the example, the polarity of the toner is negative, the potential of the photosensitive drum 2 is 0 V, and the voltage applied to the cleaning roller is −1000 V. Therefore, the potential of the photosensitive drum 2 is larger on the side opposite to the charging polarity of the toner (that is, the positive side). Consequently, the toner of the negative polarity accumulated on the cleaning roller 7 moves to the photosensitive drum 2. Naturally, as the time of applying the cleaning bias increases, the amount of toner adhered to the cleaning roller 7 decreases. In the embodiment, it was confirmed that, by setting the time to time in which the cleaning roller 7 rotates once, the cleaning roller can be sufficiently cleaned. Consequently, in the embodiment, the time of applying the cleaning bias is set to time in which the cleaning roller 7 rotates once. The time in which the cleaning roller 7 rotates once is time required for the entire peripheral surface of the gleaning roller 7 to come into contact with the photosensitive drum 2. After applying the cleaning bias only by the time in which the cleaning roller 7 rotates once, the bias applied to the cleaning roller is reset to +400 V. A region to which the toner on the cleaning roller 7 is transferred by the cleaning bias, in the surface of the photosensitive drum has a size of 215 mm (the longitudinal direction) by 37.7 mm (the rotation direction of the photosensitive drum 2). The reason is that the urethane foam sponge layer on the cleaning roller 7 has the width in the longitudinal direction of 215 mm and the periphery (the outer circumference) of the cleaning roller 7 (φ12 mm) is 37.7 mm.

In the cleaning sequence, the entire region of 215 mm (the longitudinal direction) by 37.7 mm (the rotation direction of the photosensitive drum) to which the toner on the cleaning roller 7 may be transferred is exposed by the exposing device 8. Since the surface potential of the region in the photosensitive drum 2 is changed from −700 V to −100 V to −400 V by the exposure, the toner is developed from the development roller 4 to the photosensitive drum 2. As a result, the toner transferred from the cleaning roller 7 to the photosensitive drum 2 can be prevented from being transferred from the photosensitive drum 2 to the development roller 4. The surface potential of the photosensitive drum 2 after exposure is influenced by the amount of toner on the photosensitive drum. The phenomenon will be described below.

In the cleaning sequence, different from the image formation, the photosensitive drum 2 is exposed in a state where a number of toners exist on the photosensitive drum 2, so that the potential of the photosensitive drum after exposure is influenced by the toner block effect, the influence of charges in the toners, and the like. The toner block effect is a phenomenon that, in the case where toner is adhered on the photosensitive drum 2, the toner on the photosensitive drum 2 blocks a laser beam emitted from the exposing device 8, so that decrease in the absolute value of the potential on the photosensitive drum due to exposure is reduced. The influence of charges in the toners is a phenomenon that the absolute value of the potential of the photosensitive drum 2 increases due to the charges in the toners. By the influence of the charges in the toners, according to the polarity of the toner transferred onto the photosensitive drum 2, the absolute value of the potential of the photosensitive drum 2 increases or decreases. In the embodiment, the negatively charged toner is transferred onto the negatively-charged photosensitive drum 2 by the cleaning sequence, the absolute value of the potential of the photosensitive drum 2 increases.

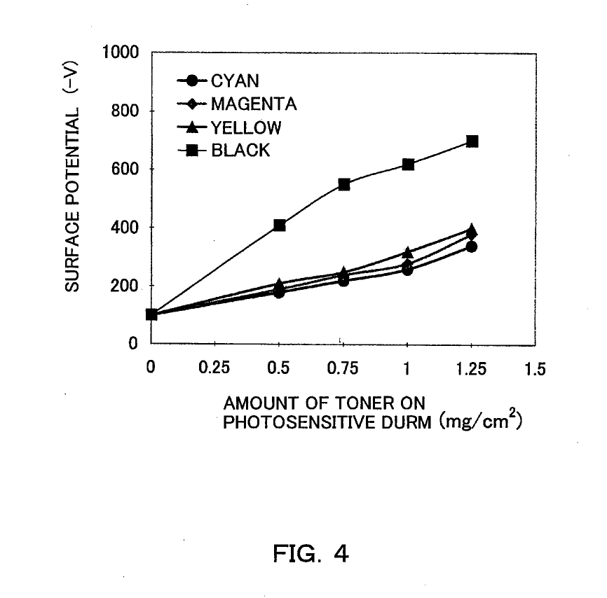

FIG. 4 is a graph showing the amount of toner on the photosensitive drum 2 and the potential of the photosensitive drum 2 after exposure. A concrete examining method of FIG. 4 is that the toner is transferred onto the photosensitive drum 2 charged to −700 V, a part on which the toner is transferred is exposed with the same exposure amount as that in the image formation, and the surface potential of the photosensitive drum 2 after exposure is measured (the amount of toner transferred to the photosensitive drum 2 is changed by the bias applied to the cleaning roller 7).

It is understood from FIG. 4 that as the amount of toner on the photosensitive drum 2 increases, the toner block effect increases, and the potential of the photosensitive drum 2 after exposure decreases. Particularly, black has the block effect larger than those of the color toners (cyan, magenta, and yellow), so that the potential of the photosensitive drum 2 after exposure decreases.

In the cleaning sequence, the amount of toner transferred from the cleaning roller 7 to the photosensitive drum 2 largely fluctuates according to the situations. In the embodiment, the amount of toner per unit area, which is transferred from the cleaning roller 7 to the photosensitive drum 2 fluctuates in the range of 0 to 1.0 (mg/cm²).

It is understood from FIG. 4 that, in the case of the color toners (cyan, magenta, and yellow), even if the toner in the range of 0 to 1.0 (mg/cm²) is transferred onto the photosensitive drum, the,surface potential of the photosensitive drum 2 after exposure is on the positive polarity side more than the development roller 4 (−400 V). Therefore, the toner can be transferred from the development roller 4 to the photosensitive drum 2 for the exposed part.

Consequently, in the image forming unit of yellow (Y), magenta (M), and cyan (C), the toner discharging operation can be executed, so that the toner transferred from the cleaning roller 7 to the photosensitive drum 2 can be prevented from being transferred to the development roller 4.

On the other hand, in the case of the black toner, as shown in FIG. 4, when toner of the amount larger than 0.5 (mg/cm²) exists on the photosensitive drum 2, the surface potential of the photosensitive drum 2 after exposure is on the negative polarity side of the developing bias (−400 V). Consequently, even if the photosensitive drum 2 is exposed, the toner discharging operation cannot be performed.

In order to enable the toner discharging operation to be performed in the image forming unit PBk of black (BK), the developing bias has to be decreased below −400 V (for example, the developing bias is changed to −800 V). Alternately, the exposure amount for performing the toner discharging operation in the cleaning sequence has to be increased to be larger than that in the image formation. However, in the image forming unit PBk of black (BK), the influence on an image of mixed colors is small. Consequently, in the embodiment, the toner discharging operation is not performed in the cleaning sequence only in the image forming unit PBk of black.

When the above operation was executed and a printing test was conducted, the following was confirmed. The cleaning operation of the cleaning roller 7 can be performed without making the toner on the cleaning roller 7 enter the developing device 9. By performing the cleaning operation of the cleaning roller 7 and the operation of discharging toner from the developing device 9 at the same time, drop in the throughput can be suppressed.

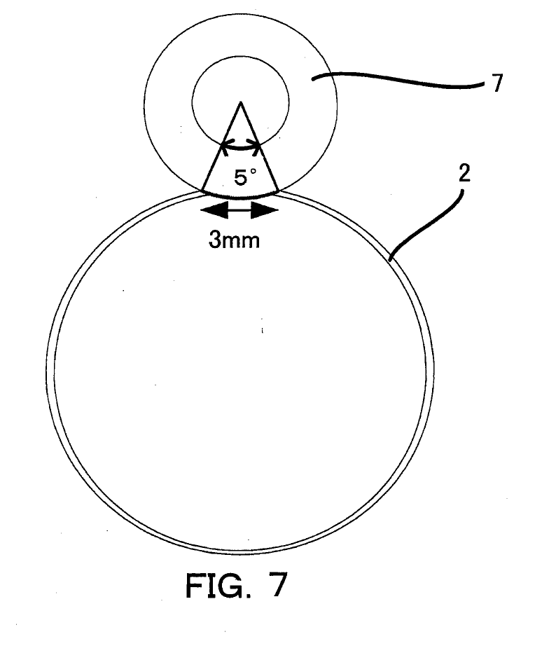

In the embodiment, the toner discharging operation is executed for the purpose of discharging the toner having low developability from the developing device 9. However, the invention is not limited to the purpose. The toner discharging operation may be executed for the purpose of discharging the mixed-color toner which entered the developing device 9 by re-transfer. In the embodiment, as the time of applying the cleaning bias in the cleaning operation, the time in which the cleaning roller 7 rotates once is set. However, the time may be slightly shorter than the time in which the cleaning roller 7 rotates once for the following reason. To clean the entire surface of the cleaning roller 7, it is sufficient that the entire surface of the cleaning roller 7 comes into contact with the photosensitive drum during the period in which the cleaning bias is applied. FIG. 7 is a schematic diagram of the hip portion between the cleaning roller 7 and the photosensitive drum 2. In the embodiment, the width of the nip portion between the cleaning roller 7 and the photosensitive drum 2 is about 3 mm, the entire surface of the cleaning roller 7 can be made contact with the photosensitive drum 2 without making the cleaning roller 7 rotate perfectly once. In the embodiment, the nip portion between the cleaning roller 7 and the photosensitive drum 2 has an angle of about 5° with respect to the rotation center of the cleaning roller 7. Consequently, even when time required for the cleaning roller 7 rotates by 355° (0.987 rotation) is set as the time of applying the cleaning bias, the cleaning roller 7 can be sufficiently cleaned.

In the cleaning sequence of the embodiment, the toner is developed on the surface part of the photosensitive drum 2 to which the toner on the cleaning roller 7 is transferred. However, to suppress consumption of the toner accompanying the toner discharging operation, the region of developing the toner may be decreased in the range where there is no problem in color mixture. In the embodiment, there is the possibility that the toner on the cleaning roller 7 is transferred to a region of 37.7 mm in the rotation direction of the photosensitive drum 2 on the surface of the photosensitive drum 2. For example, the toner may be developed from the developing device only to a region of 18.9 mm which is about the half of the region of 37.7 mm.

On the contrary, in the case where it is desired to sufficiently discharge the toner having low developability in the developing device 9 or the mixed-color toner mixed from an upstream station, the toner discharging operation may be performed on a region larger than the surface part of the photosensitive drum 2 to which the toner on the cleaning roller 7 is transferred. For example, toner may be developed from the developing device to a region of 75.4 mm which is double as the region of 37.7 mm to which the toner on the cleaning roller 7 may be transferred.

Although the toner discharging operation is executed by exposing the surface part of the photosensitive drum 2 with light by the exposing device 8 in the embodiment, the invention is not limited to the embodiment. For example, the exposing device 8 may execute the toner discharging operation by making the absolute value of the developing bias larger than that of the surface potential of the photosensitive drum 2 without exposure of the exposing device 8.

Although the same voltage as that in the image formation is applied as the developing bias in the cleaning sequence, the invention is not limited to the developing bias. The developing bias may be changed. For example, in the case where it is desired to lessen consumption of toner by the toner discharging operation, the absolute value of the developing bias may be decreased. On the contrary, in the case where it is desired to sufficiently discharge the toner having low developability in the developing device 9 or the mixed-color toner mixed from an upstream station by the toner discharging operation, the absolute value of the developing bias may be increased. In the embodiment, the cleaning bias of the negative polarity is applied to the photosensitive drum 2 in the cleaning sequence, but the invention is not limited to the embodiment. In the case where it is desired to transfer bipolar toner adhered on the cleaning roller onto the photosensitive drum 2, bipolar cleaning bias may be applied to the surface potential of the photosensitive drum 2. In the case of transferring the toner of the positive polarity from the cleaning roller 7 to the photosensitive drum 2, it is feared that the toner of the positive polarity is adhered to the charging roller 3 by the electric field. However, since the toner of the positive polarity on the photosensitive drum 2 is inverted to the toner of the negative polarity since charges are given by discharging when the toner passes through a discharge region generated near the nip portion between the charging roller 3 and the photosensitive drum 2, it is not adhered to the charging roller 3. The larger the absolute value of the charging bias is, the more the charges are given by discharging. Consequently, the absolute value of the charging bias in the cleaning sequence may be increased.

The cleaning sequence of the embodiment is performed after completion of the operation of forming an image on the 100th print as the cumulated number of prints since the last cleaning sequence (of last time) was executed. In the cleaning sequence, the number of prints is measured by measuring unit. When the number of prints reaches the preset number of 100 (set value), the cleaning operation is executed. After completion of the cleaning operation, it is sufficient to reset the measurement value of the measuring unit to the initial value (0). In such a manner, it is sufficient to execute the cleaning sequence every 100 prints.

Although the cleaning sequence is executed every 100 prints in the embodiment, the invention is not limited to the embodiment. For example, the amount of toner adhered to the cleaning roller 7 is estimated from a cumulated pixel count value of an image formed after execution of the cleaning sequence, and the timing of executing the cleaning sequence may be determined. For the operation, deriving unit that derives the number of pixels of an image formed on a single recording material may be provided. In the control unit, the number of pixels derived by the deriving unit is accumulated and, when the cumulated pixel value reaches a preset value, the cleaning operation may be executed. After completion of the cleaning operation, it is sufficient to reset the accumulated number of pixels, to the initial value (numerical value of 0). The deriving unit may derive the number of pixels of an image formed on a recording material based on image information. The number of pixels may be derived (estimated) based on irradiation time in which the exposing device 8 irradiates the photosensitive drum 2 with light.

Although entry of the toner on the cleaning roller to the developing device at the time of cleaning the toner adhered to the cleaning roller is prevented in the embodiment, the invention is not limited to the embodiment. The invention can be applied to a charging roller cleaning sequence of cleaning the toner adhered to the charging roller 3 in addition to the cleaning of the toner adhered to the cleaning roller.

### Second Embodiment

A second embodiment of the invention will be described. The basic configuration of an image forming apparatus of the second embodiment is similar to that of the first embodiment.

Therefore, the same reference numerals are designated to elements having the same functions and the same configurations as those of the image forming apparatus of the first embodiment, and the detailed description will not be described.

The second embodiment is different with respect to the point that a charging roller cleaning sequence of cleaning toner adhered to the charging roller 3 is performed in addition to the cleaning sequence of the cleaning roller 7 executed in the first embodiment. In the first embodiment, the region in which the toner discharging operation is performed is exposed by the exposing unit. In the second embodiment, the toner discharging operation is performed by controlling the developing bias without performing the exposure. In the embodiment, the charging roller 3 is a contact member which is disposed on the downstream side of the transfer position and on the upstream side of the development position and, when voltage is applied, comes into contact with the photosensitive drum 2.

The residual toners and the retransfer toners existing on the photosensitive drum 2 after the transfer step are transferred to the cleaning roller 7. The residual toners and the retransfer toners include toners passing through the nip portion between the cleaning roller 7 and the photosensitive drum 2. A part of the toners which passed through the nip portion between the cleaning roller 7 and the photosensitive drum 2 is adhered to the charging roller 3 in the nip portion between the charging roller 3 and the photosensitive drum 2. The amount of toner adhered to the charging roller 3 increases as the number of prints increases. When the amount of toner adhered to the charging roller 3 becomes equal to or larger than a predetermined amount, charging unevenness in which the surface potential of the photosensitive drum 2 is nonuniform becomes conspicuous, and an image failure occurs. In the second embodiment, therefore, a step of cleaning the toner adhered to the charging roller 3 before occurrence of an image failure caused by the charging unevenness is provided.

Specifically, each time the cumulated number of prints becomes 75, the charging roller cleaning sequence (cleaning operation) for cleaning the toner adhered to the charging roller 3 is executed. In the following, the charging roller cleaning sequence executed in the embodiment will be described. Since the cleaning sequence of the cleaning roller 7 is similar to that of the first embodiment, the description will not be described.

During image formation, by applying −1200 V as a charging bias to the core of the charging roller 3, the surface potential of the photosensitive drum 2 is charged to about −700 V. Since the charging roller 3 has a negative potential with respect to the photosensitive drum 2, the toner of the positive polarity tends to be adhered to the charging roller 3.

Due to this, cleaning operation of collecting the toner of the positive polarity in the toners adhered to the charging roller 3, in the cleaning device 15 for cleaning the conveyance belt 11 via the photosensitive drum 2 is executed.

In the charging roller cleaning sequence, the toner discharging operation is performed from the developing device 9 to the photosensitive drum 2 so that the retransfer toner transferred from the charging roller 3 to the photosensitive drum 2 is not adhered to the development roller 4, does not enter the developing device 9, is not mixed with colors.

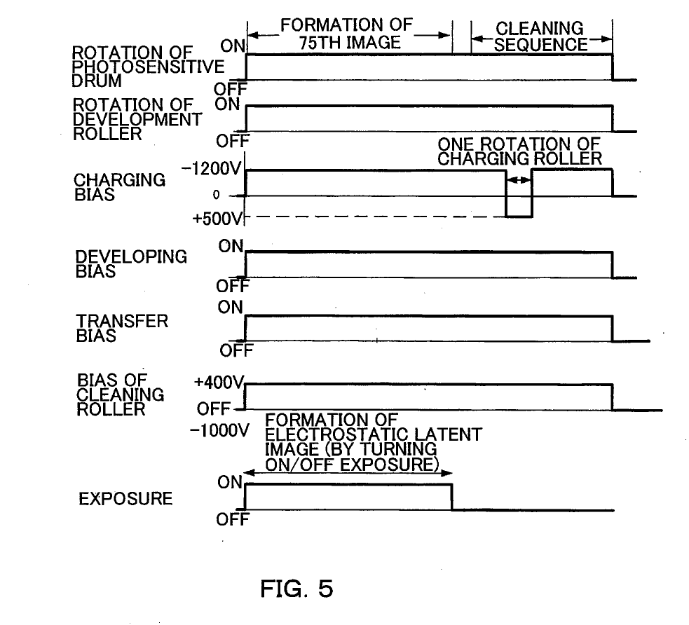

Next, the flow of the operation of forming the 75th image and the charging roller cleaning sequence executed after the operation will be described with reference to FIG. 5. FIG. 5 shows the timing chart of the charging roller cleaning sequence.

During image formation, by applying −1200 V as a charging bias to the core of the charging roller 3, the surface potential of the photosensitive drum 2 is charged to about −700 V, and an electrostatic latent image is formed by the exposing device 8. By applying −400 V as a developing bias to the core of the development roller 4, a toner image is formed on the electrostatic latent image on the photosensitive drum 2. To transfer the toner image formed on the photosensitive drum 2 onto the transfer material P, +1000 V is applied as a transfer bias to the core of the transfer roller 10.

+400 V is applied to the core of the cleaning roller 7. The toner of the negative polarity in the toners adhered on the photosensitive drum 2 after the transfer step is captured by the cleaning roller 7.

After completion of the operation of forming the 75th image, the charging roller cleaning sequence is executed. In the charging roller cleaning sequence, as the voltages applied to the development roller 4, the transfer roller 10, and the cleaning roller 7, the same voltage values as those in the image formation are continuously applied, and only the voltage applied to the charging roller 3 is changed. The surface potential of the photosensitive drum 2 is charged to −700 V by the charging roller 3, after that, is subjected to the transfer bias and the cleaning roller bias and, when the surface of the photosensitive drum 2 comes again to the position which comes into contact with the charging roller 3, becomes again 0 V to −100 V. The voltage applied to the charging roller 3 is changed from −1200 V to +500 V (hereinafter, the bias will be called a charging roller cleaning bias) with respect to the surface of the photosensitive drum 2 which becomes 0 V to −100 V. Accordingly, the toner of the positive polarity adhered to the charging roller 3 is transferred onto the photosensitive drum 2 by the potential gradient. Naturally, as the time of applying the charging roller cleaning bias increases, the amount of toner adhered to the charging roller 3 decreases. However, to shorten the charging roller cleaning sequence, the time of applying the charging roller cleaning bias is set to time in which the surface of the charging roller 3 can be cleaned to a level at which there is no problem in the charging unevenness. In the embodiment, the time of applying the charging roller cleaning bias is set as time in which the charging roller 3 rotates once. The charging roller cleaning bias is applied for only one cycle of the charging roller 3 and, after that, the bias applied to the charging roller 3 is reset to −1200 V.

The width in the longitudinal direction of the charging roller 3 is 235 mm, and the outer periphery of the charging roller 3 (φ12 mm) is 37.7 mm. Consequently, in the surface of the photosensitive drum 2, the region to which the toner adhered to the charging roller 3 by the charging roller cleaning bias is transferred is in the range of 235 mm (the longitudinal direction) by 37.7 mm (the rotation direction of the photosensitive drum 2).

Since the surface potential in the region on the photosensitive drum 2 is changed to about 0 V by application of the charging roller cleaning bias to the charging roller 3, the toner is developed from the development roller 4 onto the photosensitive drum 2. As a result, the toner transferred from the charging roller 3 to the photosensitive drum 2 can be prevented from being transferred from the photosensitive drum 2 to the development roller 4. As described above, in the embodiment, by controlling the developing bias with respect to the potential of the photosensitive drum so that the toner shifts, the toner discharging operation is performed without performing exposure.

When the charging roller cleaning sequence as described above was executed and a printing test was conducted, the charging roller 3 could be cleaned without making the toner on the charging roller 3 enter the developing device.

In the embodiment, the developing bias in the toner discharging operation is set to the same voltage as that in the image formation. In the case of changing the toner amount in the toner discharging operation, the developing bias may be changed to that in the image formation.

In the embodiment, in the charging roller cleaning sequence, +500 V is applied as the charging roller cleaning bias. However, the invention is not limited to the above. In the case of transferring both the toner of the positive polarity and the toner of the negative polarity adhered to the charging roller 3 to the photosensitive drum 2, a plurality of charging roller cleaning biases of different electric field directions are applied across the charging roller 3 and the photosensitive drum 2. The toner discharging operation may be performed by exposing the photosensitive drum 2 by the exposing device 8. Also in the case where both of the toners of the positive and negative polarities are discharged, when the toner discharging operation is performed from the developing device to the photosensitive drum, movement of the toner from the photosensitive drum 2 to the development roller 4 is hindered. Thus, the toner is hardly collected by the developing device 9 regardless of the polarity of the toner.

In the embodiment, as the time of applying the charging roller cleaning bias in the charging roller cleaning sequence, the time in which the charging roller 3 rotates once is set but time slightly shorter than the time in which the charging roller 3 rotates once may be also set. The reason is that, to clean the toner adhered to the outer peripheral face of the charging roller 3, it is sufficient to make the entire circumferential face of the charging roller 3 come into contact with the photosensitive drum 2 during the period in which the charging roller cleaning bias is applied.

In the embodiment, a contact nip portion is formed between the charging roller 3 and the photosensitive drum 2. The contact nip portion between the charging roller 3 and the photosensitive drum 2 has an angle of about 45° with respect to the center of the charging roller 3, and the nip width is about 4 mm. To make the entire circumferential face of the charging roller 3 come into contact with the photosensitive drum 2, it is sufficient to make the charging roller 3 rotate by 315° obtained by subtracting 45° of the contact nip portion from 360°. Consequently, when time required for the charging roller 3 to rotate by 315° (0.875 rotation) is set as the time of applying the cleaning bias, the charging roller 3 can be sufficiently cleaned. It has been described that, in the charging roller cleaning sequence, the application time of the charging roller cleaning bias may be shorter than the time in which the charging roller 3 rotates once. Also in the case of cleaning the cleaning roller 7, the cleaning bias application time can be set shorter than the time in which the cleaning roller 7 rotates once.

In the embodiment, the example of using both of the charging roller cleaning sequence and the cleaning sequence of the cleaning roller 7 has been described. However, the invention is not limited to the example. For example, the invention is also effective in an image forming apparatus performing only the charging roller cleaning sequence. That is, the invention can be also applied to the case of preventing toner from being transferred to the developing device 9 at the time of collecting the toner transferred from the charging roller 3 into the cleaning device 15 for cleaning the conveyance belt 11.

### Third Embodiment

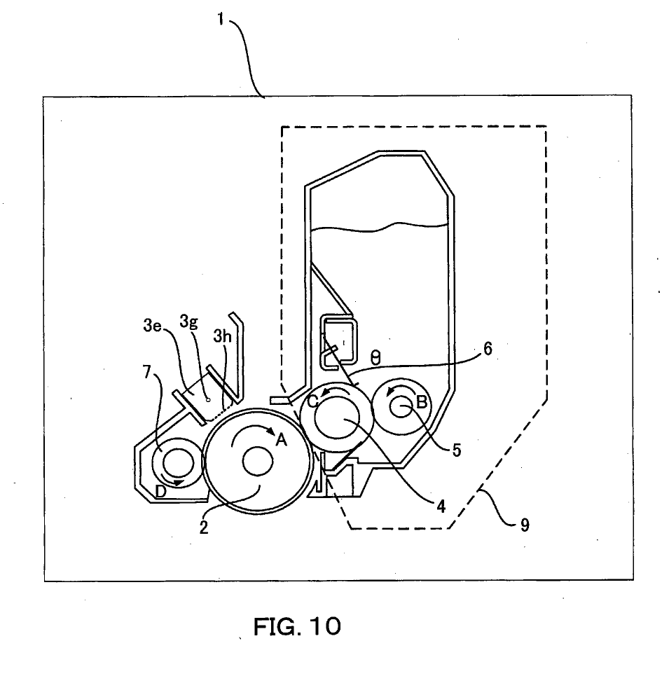

A third embodiment of the invention will be described. The basic configuration of an image forming apparatus of the third embodiment is similar to that of the first embodiment. Therefore, the same reference numerals are designated to elements having the same functions and the same configurations as those of the image forming apparatus of the first embodiment, and the detailed description will not be described. The third embodiment is different with respect to the point that a corona charger is employed in the third embodiment while the charging roller 3 is used as charging unit in the first embodiment. FIG. 10 is a cross-sectional view showing a schematic configuration of a process cartridge of the embodiment.

The point different from the cleaning sequence of the cleaning roller 7 of the first embodiment is that the toner discharging operation is performed by changing the charging bias and the developing bias, not exposure by the exposing device 8. Also in the third embodiment, in a manner similar to the first embodiment, the timing of executing the cleaning sequence is after completion of the operation of forming the 100th image as the cumulated number of prints (the number of images formed) since the last cleaning sequence was executed.

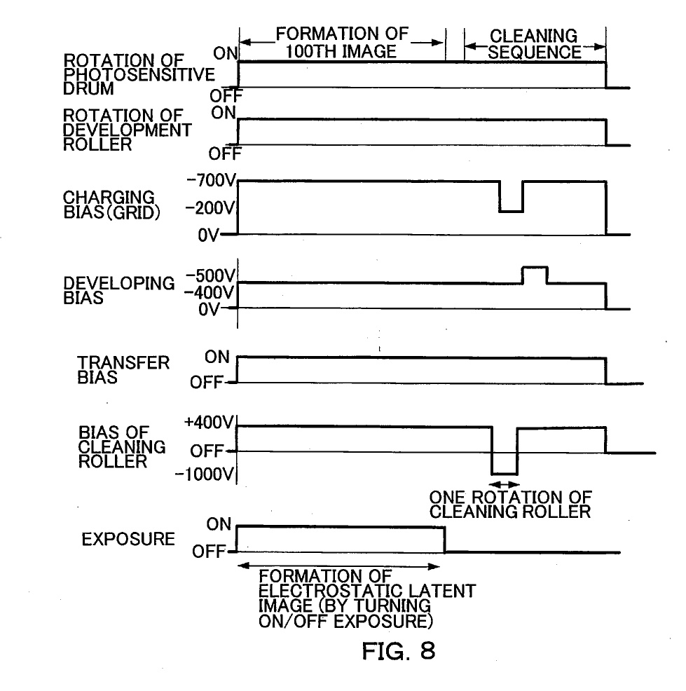

In the following, the cleaning sequence of the cleaning roller 7 of the embodiment and the toner discharging operation will be described with reference to FIG. 8. FIG. 8 is a timing chart of the operation of forming the 100th image and the cleaning sequence executed after that.

During the image formation, DC voltage is applied to a corona discharge wire 3g of a corona charger 3e and the core of a grid 3h. Specifically, a DC voltage of −4.5 kV is applied to the corona discharge wire, and a DC voltage of −700 V is applied to the grid 3h. The corona charger 3e can charge the surface potential of the photosensitive drum 2 to a bias which is almost the same as the grid bias applied to the grid 3h. Consequently, during the image formation, by applying the DC voltage of −700 V to the grid 3h, the surface potential of the photosensitive drum 2 is charged to −700 V.

By applying −400 V as the developing bias to the core of the development roller 4, a toner image is developed on the electrostatic latent image on the photosensitive drum 2. To transfer the toner image on the photosensitive drum 2 onto the recording material P, +1000 V is applied as a transfer bias to the core of the transfer roller 10. To temporarily store the toner of the negative polarity in the toners adhered to the photosensitive drum 2 after the transfer step onto the cleaning roller 7, +400 V is applied to the core of the cleaning roller 7.

After completion of the operation of forming the 100th image, the cleaning sequence is executed. In the cleaning sequence, by changing the voltage applied to the cleaning roller 7 from +400 V to −1000 V to generate a potential gradient, the toner is transferred onto the photosensitive drum 2. The time of applying −1000 V to the cleaning roller 7 is set to the time in which the cleaning roller 7 rotates once.

The surface potential of the photosensitive drum 2 is charged to −700 V like in the image formation by the corona charger 3e , after that, subjected to the transfer bias, and becomes 0 V to about −100 V when the surface of the photosensitive drum 2 comes again to the position which comes into contact with the cleaning roller 7. Therefore, the toner of the negative polarity accumulated on the cleaning roller 7 is transferred onto the photosensitive drum 2 by the potential gradient between the photosensitive drum 2 and the cleaning roller 7. In a manner similar to the first embodiment, the time of applying the cleaning bias is set to the time in which the cleaning roller 7 rotates once. After applying the cleaning bias only by the time in which the cleaning roller 7 rotates once, the bias applied to the cleaning roller is reset to +400 V. The region to which the toner on the cleaning roller 7 is transferred (transfer region) by the cleaning bias in the surface of the photosensitive drum is a range of 215 mm (the longitudinal direction) by 37.7 mm (the rotation direction of the photosensitive drum 2). The reason is that the width in the longitudinal direction of the urethane foam sponge layer on the cleaning roller 7 is 215 mm, and one circumference of the cleaning roller 7 (φ12 mm) is 37.7 mm.

In the cleaning sequence, the grid bias is changed from −700 V to −200 V only for a period in which the transfer region to which the toner on the cleaning roller 7 may be transferred passes through the discharge region of the corona charger 3e and the photosensitive drum 2. After the transfer region pasted through the discharge region of the corona charger 3e and the photosensitive drum 2, the grid bias is reset again to −700 V.

Since the surface potential of the transfer region of the photosensitive drum 2 changes to −200 V by changing the grid bias, the toner is developed from the development roller 4 to the photosensitive drum 2. Only by the period in which the transfer region passes through the nip portion between the development roller 4 and the photosensitive drum 2, the developing bias is changed from −400 V to −500 V. By increasing the potential difference between the photosensitive drum 2 and the development roller 4, the toner is sufficiently developed. As a result, the toner transferred from the cleaning roller 7 to the photosensitive drum 2 can be prevented from being transferred from the photosensitive drum 2 to the development roller 4.

In the embodiment, the exposing device 8 is not used but the charging bias (grid bias) is changed in order to change the surface potential of the photosensitive drum 2 to perform the toner discharging operation. In the case of changing the surface potential of the photosensitive drum 2 with exposure of the exposing device 8, as described in the first embodiment, when the amount of toner existing on the photosensitive drum 2 is large, the surface potential of the photosensitive drum may not be stabilized due to the toner block effect.

In the third embodiment, the surface potential of the photosensitive drum 2 is changed by changing the charging bias, so that the laser beam of the exposing device 8 is not blocked by the toner. There is an effect that the potential of the photosensitive drum is stabilized. In the third embodiment, the developing bias is changed in the toner discharging operation. However, the developing bias does not have to be changed.

### Fourth Embodiment

A fourth embodiment of the invention will now be described. The basic configuration of an image forming apparatus of the fourth embodiment is similar to that of the first embodiment. Therefore, the same reference numerals are designated to elements having the same functions and the same configurations as those of the image forming apparatus of the first embodiment, and the detailed description will not be described. The point different from the first embodiment is that a positively-charged toner is used and regular development (charged area development) is performed.

The exposing device 8 exposes a part to which no toner is adhered in the surface of the photosensitive drum 2 which is negatively charged by the charging roller 3, thereby forming an electrostatic latent image. Positively-charged toner is regularly developed to the formed electrostatic latent image by the developing device 9. An image forming unit of the fourth embodiment will now be described.

### <Description of Image Forming Unit>

A DC voltage of −1200 V is applied to the core of the charging roller 3 as charging bias to charge the periphery of the photosensitive drum 2 to about −700 V. Next, an electrostatic latent image is formed by irradiating the surface of the photosensitive drum 2 which is charged to −700 V with a laser beam by the exposing device 8. Different from the first embodiment, the exposing device 8 exposes a part to which no toner is adhered in the surface of the photosensitive drum 2 and does not expose a part to which toner is adhered, thereby forming an electrostatic latent image. The electrostatic latent image formed on the photosensitive drum 2 is visualized by the developing device 9.

Next, the developing device 9 will be described.

The developing device 9 of the embodiment has the same configuration as that of the first embodiment. The different point is that a positively-charged nonmagnetic monocomponent toner is used as the toner. A DC voltage of −400 V is applied as the developing bias to the core of the development roller 4. Since a part which is not exposed by the exposing device 8 in the surface of the photosensitive drum 2 is charged so that the potential becomes about −700 V, the positively-charged toner on the development roller 4 is developed on the photosensitive drum 2. On the other hand, the potential of the part exposed by the exposing device 8 is neutralized to about −100 V, so that the toner is hardly transferred from the developing device 9.

When negative DC voltage is applied to the transfer roller 10, the toner image formed on the photosensitive drum 2 is transferred onto the recording material P carried and conveyed on the conveyance belt 11. The place where transfer is performed will be called a transfer position.

To collect toner adhered on the surface of the photosensitive drum 2 and temporarily hold it after the transfer step (transfer operation), a DC voltage of −1100 V is applied to the cleaning roller 7.

When the cleaning roller 7 comes into contact with the surface of the photosensitive drum 2, the toner of the positive polarity adhered to the photosensitive drum 2 after the transfer step is eliminated, and adhesion of toner to the surface of the charging roller 3 is prevented. During a print job (in image formation), the toner adhered on the photosensitive drum 2 after the transfer step is temporarily stored on the cleaning roller 7. When the cleaning sequence (cleaning operation) is executed in no image forming time, the toner accumulated on the cleaning roller 7 is collected (discarded) by the cleaning apparatus 15 via the photosensitive drum 2 and the conveyance belt 11. The cleaning sequence is executed by control unit provided for the image forming apparatus 100.

Like in the first embodiment, in the cleaning sequence, the toner discharging operation of developing (supplying) the toner on the development roller 4 onto the photosensitive drum 2 is executed to prevent color mixture.

### <Cleaning Sequence and Toner Ejecting Operation>

The timing of executing the cleaning sequence is after completion of the operation of forming the 100th image as the cumulated number of prints (the number of images formed) since the last cleaning sequence was executed.

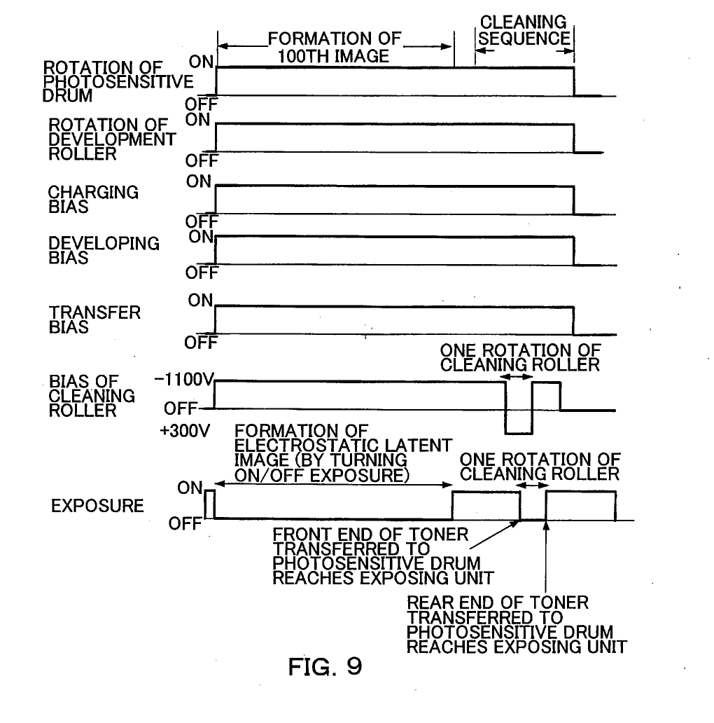

The flow of the operation of forming the 100th image and the cleaning sequence executed after that will be described with reference to FIG. 9. During the image formation, by applying −1200 V as the charging bias to the core of the charging roller 3, the surface potential of the photosensitive drum 2 is charged to about −700 V. By applying −400 V as the developing bias to the core of the development roller 4, a toner image is developed in an unexposed part on the photosensitive drum 2. To transfer the toner image on the photosensitive drum 2 onto the recording material P, −1700 V is applied as a transfer bias to the core of the transfer roller 10. To temporarily accumulate the toner of the positive polarity in the toners adhered to the photosensitive drum 2 after the transfer step onto the cleaning roller 7, −1100 V is applied to the core of the cleaning roller 7.

After completion of the operation of forming the 100th image, the cleaning sequence is executed. In the cleaning sequence, the same voltages as those in the image formation are successively applied to the charging roller 3, the development roller 4, and the transfer roller 10, and only the cleaning bias to be applied to the cleaning roller 7 is changed. The cleaning bias is changed from −1100 V to +300 V to generate a potential gradient. The surface potential of the photosensitive drum 2 is charged to −700 V like in the image formation by the charging roller 3, after that, subjected to the transfer bias, and becomes 0 V to about −100 V when the surface of the photosensitive drum 2 comes again to the position which comes into contact with the cleaning roller 7. Therefore, the toner of the positive polarity accumulated on the cleaning roller 7 is transferred onto the photosensitive drum 2 by the potential gradient between the photosensitive drum 2 and the cleaning roller 7.

Naturally, as the time of applying the cleaning bias increases, the amount of toner adhered to the cleaning roller 7 decreases. In the embodiment, it was confirmed that, by setting the time to time in which the cleaning roller 7 rotates once, the cleaning roller can be sufficiently cleaned. Consequently, in the embodiment, the time of applying the cleaning bias is set to time in which the cleaning roller 7 rotates once. The time in which the cleaning roller 7 rotates once is time required for the entire peripheral surface of the cleaning roller 7 to come into contact with the photosensitive drum 2. After applying the cleaning bias only by the time in which the cleaning roller 7 rotates once, the bias applied to the cleaning roller is reset to −1100 V. A region to which the toner on the cleaning roller 7 is transferred by the cleaning bias, in the surface of the photosensitive drum 2 has a range of 215 mm (the longitudinal direction) by 37.7 mm (the rotation direction of the photosensitive drum 2).

In the cleaning sequence, only the region of 215 mm (the longitudinal direction) by 37.7 mm (the rotation direction of the photosensitive drum) to which the toner on the cleaning roller 7 may be transferred is not exposed by the exposing device 8. The entire surface of the photosensitive drum 2 except for the region is exposed. Since the surface potential of the surface of the photosensitive drum 2 to which the toner is transferred from the cleaning roller 7 remains −700 V, the positively-charged toner is developed on the photosensitive drum 2 from the development roller 4. As a result, the toner transferred from the cleaning roller 7 to the photosensitive drum 2 can be prevented from being transferred from the photosensitive drum 2 to the development roller 4.

Although the toner adhered on the cleaning roller 7 is transferred to the photosensitive drum 2 as the cleaning sequence in the embodiment, the invention is not limited to the embodiment. For example, the invention can be also applied to a charging roller cleaning sequence of transferring toner adhered on the charging roller 3 which comes into contact with the photosensitive drum 2 onto the photosensitive drum 2 as in the second embodiment. For example, in a manner similar to the second embodiment, as the charging roller cleaning sequence, the voltage applied to the charging roller 3 is set to +500 V, and the toner adhered on the charging roller is transferred to the photosensitive drum 2. A developer may be transferred from the developing unit to a region where the transferred toner exists.

In the foregoing embodiments, the nonmagnetic monocomponent contact developing method is employed as the developing method. However, the invention is not limited to the method, and a two-component developing method may be employed. In the foregoing embodiments, at the time of cleaning the toner adhered on the cleaning roller, entry of the toner on the cleaning roller to the developing device is prevented. However, the invention is not limited to the embodiments. The invention may be applied to the case of toner adhered to a cleaning brush or a fixed holding member.

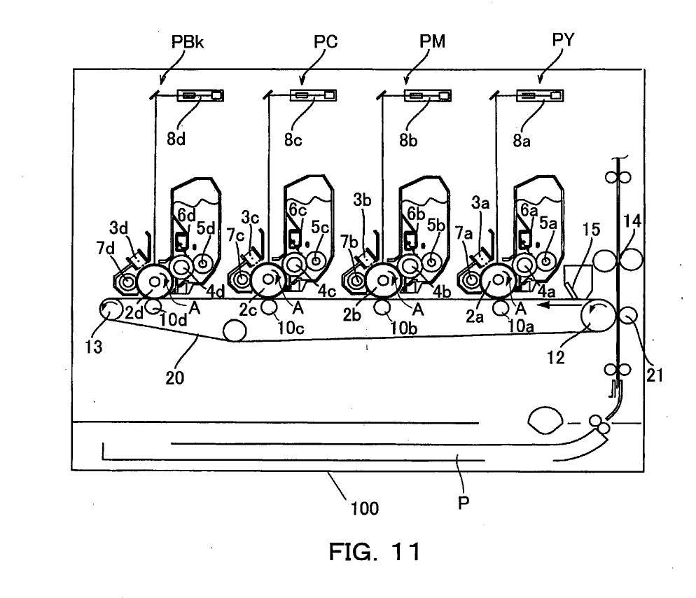

Although the method of transferring an image onto the recording material P carried and conveyed by the conveyance belt 11 in the transfer step has been described in the embodiments, the invention is not limited to the described method. The present invention can be also suitably applied to an image forming apparatus of a type of performing the transfer step on an intermediate transfer member as shown in FIG. 11.

In the type of performing the transfer step on an intermediate transfer member, the toner images formed on the photosensitive drums 2 are primarily transferred onto the intermediate transfer member (intermediate transfer belt) 20 when the DC voltage is applied to the transfer roller 10. And then the toner images formed on the intermediate transfer belt 20 are secondarily transferred onto the recording material P when the DC voltage is applied to a secondary transfer roller 21. The image forming apparatus as shown in FIG. 11 is different from the embodiments in the transfer step. In FIG. 11, components similar to those in the embodiments are represented by the same numbers, and thus description thereof will be omitted.

In the image forming apparatus as shown in FIG. 11, by executing a cleaning sequence (cleaning operation) when no image is formed, the toner accumulated on the cleaning roller 7 is collected (discarded) by the cleaning device 15 as a collecting member via the photosensitive drum 2 and the intermediate transfer belt 20.

In the embodiments as described above, toner from the developing device 9 is transferred to the surface of the photosensitive drum 2 to which the toner is transferred in the operation of cleaning the contact member. Consequently, with the simple configuration, entry of the toner transferred from the contact member (such as the charging roller 3 and the cleaning roller 7) which comes into contact with the photosensitive drum 2 into the developing device 9 can be suppressed. The reason is that toner is transferred from the development roller 4 onto the photosensitive drum 2 by the developer discharging operation, so that movement of the toner from the photosensitive drum 2 to the development roller 4 is disturbed.

Since the operation of cleaning the contact member and the operation of discharging toner of the developing device 9 can be performed simultaneously, deterioration in the throughput can be lessened.

The present invention is effectively applied to the image forming apparatus that performs the cleaning operation of collecting toner held on the contact member which comes into contact with the photosensitive drum by the cleaning device 15 for cleaning the conveyance belt 11 (or the intermediate transfer member) via the photosensitive drum 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-94133, filed on Apr. 8, 2009, and Japanese Patent Application No. 2010-54867, filed on Mar. 11, 2010, which are hereby incorporated by reference herein in its entirety.

What is claimed is:

1. An image forming apparatus comprising:
a rotatable image bearing member;
a charging unit that charges the image bearing member in a charging position;
an exposing unit that exposes the image bearing member to form an electrostatic latent image on the image bearing member;
a developing unit of a reversal development type that performs development by transferring a developer to a part exposed by the exposing unit in the electrostatic latent image formed on the image bearing member;
a transfer member that transfers a developer image on the image bearing member developed by the developing unit in a transfer position to a recording material carried by a recording material conveying member or an intermediate transfer member;
a holding member that is disposed on the downstream side of the transfer position in the rotating direction of the image bearing member and on the upstream side of the charging position as coming into contact with the image bearing member, when voltage is applied, holds the developer;
a collecting member that collects the developer adhered to the recording material conveying member or the intermediate transfer member; and
a control unit that controls voltage applied to the transfer member and the holding member,
wherein the control unit controls the voltage applied to the transfer member and the holding member to transfer the developer held on the holding member to the recording material conveying member or the intermediate transfer member via the image bearing member, and executes cleaning operation of performing the collection by the collecting member, and
at the time of the cleaning operation, executes a developer discharging operation of exposing at least a part of a surface part to which the developer is transferred from the holding member in the surface part of the image bearing member by the exposing unit and transferring the developer from the developing unit.

2. An image forming apparatus comprising:
a rotatable image bearing member;
a charging unit that charges the image bearing member in a charging position;
a developing unit that develops an electrostatic latent image formed on the image bearing member with a developer;
a transfer member that transfers a developer image on the image bearing member developed by the developing unit in a transfer position to a recording material carried by a recording material conveying member or an intermediate transfer member;
a holding member that is disposed on the downstream side of the transfer position in the rotating direction of the image bearing member and on the upstream side of the charging position as coming into contact with the image bearing member, when voltage is applied, holds the developer;
a collecting member that collects the developer adhered to the recording material conveying member or the intermediate transfer member; and
a control unit that controls voltage applied to the transfer member, the holding member, the developing unit, and the charging unit,
wherein the control unit controls the voltage applied to the transfer member and the holding member to transfer the developer held on the holding member to the recording material conveying member or the intermediate transfer member via the image bearing member, and executes cleaning operation of performing the collection by the collecting member, and
the control unit controls at least one of the voltage applied to the developing unit and the voltage applied to the charging unit and, at the time of the cleaning operation, executes a developer discharging operation of transferring the developer from the developing unit to at least a part of a surface part to which the developer is transferred from the holding member in the surface part of the image bearing member.

3. An image forming apparatus comprising:
a rotatable image bearing member;
a charging unit that comes into contact with the image bearing member and charges the image bearing member in a charging position;
an exposing unit that exposes the image bearing member to form an electrostatic latent image on the image bearing member;
a developing unit of a reversal development type that performs development by transferring a developer to a part exposed by the exposing unit in the electrostatic latent image formed on the image bearing member;
a transfer member that transfers a developer image on the image bearing member developed by the developing unit in a transfer position to a recording material carried by a recording material conveying member or an intermediate transfer member;
a collecting member that collects the developer adhered to the recording material conveying member or the intermediate transfer member; and
a control unit that controls voltage applied to the transfer member and the charging unit,
wherein the control unit controls the voltage applied to the transfer member and the charging unit to transfer the developer adhered to the charging unit to the recording material conveying member or the intermediate transfer member via the image bearing member, and executes cleaning operation of performing the collection by the collecting member, and
at the time of the cleaning operation, executes a developer discharging operation of exposing at least a part of a surface part to which the developer is transferred from the charging unit in the surface part of the image bearing member by the exposing unit and transferring the developer from the developing unit.

4. An image forming apparatus comprising:
a rotatable image bearing member;
a charging unit that comes into contact with the image bearing member and charges the image bearing member in a charging position;
a developing unit that develops an electrostatic latent image formed on the image bearing member with a developer;
a transfer member that transfers a developer image on the image bearing member developed by the developing unit in a transfer position to a recording material carried by a recording material conveying member or an intermediate transfer member;
a collecting member that collects the developer adhered to the recording material conveying member or the intermediate transfer member; and
a control unit that controls voltage applied to the transfer member, the charging unit, and the developing unit,
wherein the control unit controls the voltage applied to the transfer member and the charging unit to transfer the developer adhered to the charging unit to the recording material conveying member or the intermediate transfer member via the image bearing member, and executes cleaning operation of performing the collection by the collecting member, and
the control unit controls the voltage applied to the developing unit and, at the time of the cleaning operation, executes a developer discharging Operation of transferring the developer from the developing unit to at least a part of a surface part to which the developer is transferred from the charging unit in the surface part of the image bearing member.

5. An image forming apparatus comprising:
a rotatable image bearing member;
a charging unit that charges the image bearing member in a charging position;
an exposing unit that exposes the image bearing member to form an electrostatic latent image on the image bearing member;
a developing unit of a regular development type that performs development by transferring a developer to a part which is not exposed by the exposing unit in the electrostatic latent image formed on the image bearing member;
a transfer member that transfers a developer image on the image bearing member developed by the developing unit in a transfer position to a recording material carried by a recording material conveying member or an intermediate transfer member;
a holding member that is disposed on the downstream side of the transfer position in the rotating direction of the image bearing member and on the upstream side of the charging position as coming into contact with the image bearing member, when voltage is applied, holds the developer;
a collecting member that collects the developer adhered to the recording material conveying member or the intermediate transfer member; and
a control unit that controls voltage applied to the transfer member, the holding member, and the developing unit,
wherein the control unit controls the voltage applied to the transfer member and the holding member to transfer the developer held on the holding member to the recording material conveying member or the intermediate transfer member via the image bearing member, and executes cleaning operation of performing the collection by the collecting member, and
at the time of the cleaning operation, executes a developer discharging operation of transferring the developer from the developing unit by not exposing, by the exposing unit, at least a part of a surface part to which the developer is transferred from the holding member in the surface part of the image bearing member.

6. An image forming apparatus comprising:
a rotatable image bearing member;
a charging unit that comes into contact with the image bearing member and charges the image bearing member in a charging position;
an exposing unit that exposes the image bearing member to form an electrostatic latent image on the image bearing member;
a developing unit of a regular development type that performs development by transferring a developer to a part which is not exposed by the exposing unit in the electrostatic latent image formed on the image bearing member;
a transfer member that transfers a developer image on the image bearing member developed by the developing unit in a transfer position to a recording material carried by a recording material conveying member or an intermediate transfer member;
a collecting member that collects the developer adhered to the recording material conveying member or the intermediate transfer member; and
a control unit that controls voltage applied to the transfer member, the charging unit, and the developing unit,
wherein the control unit controls the voltage applied to the transfer member and the charging unit to transfer the developer adhered to the charging unit to the recording material conveying member or the intermediate transfer member via the image bearing member, and executes cleaning operation of performing the collection by the collecting member, and
at the time of the cleaning operation, executes a developer discharging operation of transferring the developer from the developing unit by not exposing, by the exposing unit, at least a part of a surface part to which the developer is transferred from the charging unit in the surface part of the image bearing member.

7. The image forming apparatus according to claim 1, wherein the holding member is a rotation member, the holding member is provided so as to rotate while being in contact with the surface of the image bearing member, and
in the cleaning operation, the control unit generates a potential gradient for transferring the developer on the holding member to the image bearing member for time required for the entire peripheral surface of the holding member to come into contact with the image bearing member.

8. The image forming apparatus according to claim 2, wherein the holding member is a rotation member, the holding member is provided so as to rotate while being in contact with the surface of the image bearing member, and
in the cleaning operation, the control unit generates a potential gradient for transferring the developer on the holding member to the image bearing member for time required for the entire peripheral surface of the holding member to come into contact with the image bearing member.

9. The image forming apparatus according to claim 5, wherein the holding member is a rotation member, the holding member is provided so as to rotate while being in contact with the surface of the image bearing member, and
in the cleaning operation, the control unit generates a potential gradient for transferring the developer on the holding member to the image bearing member for time required for the entire peripheral surface of the holding member to come into contact with the image bearing member.

10. The image forming apparatus according to claim 3, wherein the charging unit is a rotation member, the charging unit is provided so as to rotate while being in contact with the surface of the image bearing member, and
in the operation of cleaning the charging unit, the control unit generates a potential gradient for transferring the developer on the charging unit to the image bearing member for time required for the entire peripheral surface of the charging unit to come into contact with the image bearing member.

11. The image forming apparatus according to claim 4, wherein the charging unit is a rotation member, the charging unit is provided so as to rotate while being in contact with the surface of the image bearing member, and
in the operation of cleaning the charging unit, the control unit generates a potential gradient for transferring the developer on the charging unit to the image bearing member for time required for the entire peripheral surface of the charging unit to come into contact with the image bearing member.

12. The image forming apparatus according to claim 6, wherein the charging unit is a rotation member, the charging unit is provided so as to rotate while being in contact with the surface of the image bearing member, and
in the operation of cleaning the charging unit, the control unit generates a potential gradient for transferring the developer on the charging unit to the image bearing member for time required for the entire peripheral surface of the charging unit to come into contact with the image bearing member.
